(19) United States
(12) Patent Application Publication
(10) Pub. No.: US 2008/0222848 A1
(43) Pub. Date: Sep. 18, 2008

(54) Cover Capable of Supporting Diary or Calendar

(76) Inventor: Jeong-Woo Park, Cheonan-si Chungnam (KR)

Correspondence Address: IPLA P.A., 3580 WILSHIRE BLVD., 17TH FLOOR, LOS ANGELES, CA, 90010, US

(21) Appl. No.: 12/066,351

(22) PCT Filed: Sep. 7, 2006
(86) PCT No.: PCT/KR2006/003547

§ 371 Date: Mar. 10, 2008

(30) Foreign Application Priority Data
Sep. 8, 2005 (KR) 10-2005-0083591
Sep. 7, 2006 (KR) PCT/KR2006/003547

(51) Int. Cl. B42D 3/10

(52) U.S. Cl. 24/2

(57) ABSTRACT

A multipurpose supportable cover having improved portability and usability, the cover including a front cover 20, a filler page portion 30, and a rear cover 40 that are bound by a binder 10, wherein a first iron piece 21 is installed on a lower end of the front cover 20, the rear cover 40 includes a main rear cover 42, a first sub-rear cover 43, and a second sub-rear cover 44 that are partitioned by first and second folding lines 40a and 40b, and a magnet piece 41 to be attached to the first iron piece 21 is installed on a lower end of the second sub-rear cover 44.

### TECHNICAL FIELD

The present invention relates to a multipurpose supportable cover that provides improved portability and usability.

### BACKGROUND ART

Schedulers include a filler page portion on which various forms of scratch paper to write schedules, memos, addresses, telephone numbers, etc. thereon, a map including various useful pieces of information, and a route map including information such as subway routes are printed. Such schedulers are widely used by salary persons and students.

Meanwhile, calendars are manufactured by binding pages displaying months or weeks with two thick boards serving as a front cover and a rear cover. When the front and rear cover are stretched out, the calendar turns into a triangular support and is thus used standing on a table.

Such schedulers or calendars are very useful in daily lives or business and thus widely used.

However, schedulers or calendars are sold as separate products and used separately, so that they are not convenient for users. For example, in home or offices, users usually write down important schedules, anniversaries, appointments, etc. in calendars, but calendars are not easy to be carried. Hence, it is not easy to check appointments or schedules written down on calendars while going out or moving. Thus, users have to write down appointments or schedules on schedulers twice separately from on the calendars. On the other hand, current schedulers cannot be used standing on a table although including a calendar.

### DISCLOSURE OF INVENTION

### Technical Problem

The present invention provides a multipurpose supportable cover improved in portability and usability so as to serve as both a scheduler and a calendar.

The present invention also provides a multipurpose supportable cover capable of improving the portability and usability of a notepad (or a notebook), a name card book (or an address book), and a book (or a picture album) by being applied thereto.

### Technical Solution

According to an aspect of the present invention, there is provided a multipurpose supportable cover that provides improved portability and usability, the cover comprising a front cover 20, a filler page portion 30, and a rear cover 40 that are bound by a binder 10, wherein a first iron piece 21 is installed on a lower end of the front cover 20, the rear cover 40 comprises a main rear cover 42, a first sub-rear cover 43, and a second sub-rear cover 44 that are partitioned by first and second folding lines 40a and 40b, and a magnet piece 41 to be attached to the first iron piece 21 is installed on a lower end of the second sub-rear cover 44.

According to another aspect of the present invention, there is provided a multipurpose supportable cover that provides improved portability and usability, the cover comprising a front cover 120, a filler page portion 130, and a rear cover 140 that are bound by a binder 110, wherein a first magnet piece 121 is installed on a lower end of the front cover 120, the rear cover 140 comprises a main rear cover 142, a first sub-rear cover 143, and a second sub-rear cover 144 that are partitioned by first and second folding lines 140a and 140b, and an iron piece 141 to be attached to the first magnet piece 121 is installed on a lower end of the second sub-rear cover 144.

According to another aspect of the present invention, there is provided a multipurpose supportable cover that provides improved portability and usability, the cover comprising a front cover 220 (320), a filler page portion 230 (330), and a rear cover 240 (340) that are bound by a binder 210 (310), wherein the rear cover 240 (340) comprises a main rear cover 242 (342) and a sub-rear cover 243 (343) that are partitioned by a folding line 240a (340a).

A lower portion of the main rear cover 242 (342) is horizontally stepped to be turned into a stepped portion 242a (342a) thinner than the other portion of the main rear cover 242 (342). When the sub-rear cover 243 (343) is folded about the folding line 240a (340a) to face the stepped portion 242a (342a).

An insertion piece 244 having a concave cross-section so that an end of the front cover 220 is inserted into the insertion piece 244 is installed on an end of the sub-rear cover 243.

A first magnetic body is installed on one of an end of the sub-rear cover 343 and an end of the front cover 320, and a second magnetic body to be attached to the first magnetic body is installed on the remaining end.

According to another aspect of the present invention, there is provided a multipurpose supportable cover that provides improved portability and usability, the cover comprising a front cover 420 (520), a filler page portion 430 (530), and a rear cover 540 (540) that are bound by a binder 410 (510), wherein the front cover 420 (520) comprises a main rear cover 422 (522) and a sub-rear cover 423 (523) that are partitioned by a folding line 420a (520a), and the rear cover 440 (540) comprises a main front cover 442 (542) and a sub-front cover 443 (543) that are partitioned by a folding line 440a (540a).

A lower portion of the main front cover 422 (522) is horizontally stepped to be turned into a stepped portion 422a (522a) thinner than the other portion of the main rear cover 422 (522), and when the sub-rear cover 423 (523) is folded about the folding line 420a (520a), it faces the stepped portion 422a (522a). A lower portion of the main rear cover 442 (542) is horizontally stepped to be turned into a stepped portion 442a (542a) thinner than the other portion of the main rear cover 442 (542), and when the sub-rear cover 443 (543) is folded about the folding line 440a (540a), it faces the stepped portion 442a (542a).

A first magnetic body is installed on one of an end of the sub-front cover 423 and an end of the sub-rear cover 443, and a second magnetic body to be attached to the first magnetic body is installed on the remaining end.

A first magnetic body is installed in one of the sub-front cover 523 and the sub-rear cover 543, and a second magnetic body to be attached to the first magnetic body is installed in the remaining cover.

According to another aspect of the present invention, there is provided a multipurpose supportable cover that provides improved portability and usability, the cover comprising a front cover 620, a filler page portion 630, and a rear cover 640 that are bound by a binder 610, wherein a first magnet piece 621 is installed on the front cover 620, a first sub-rear cover 643 and a second sub-rear cover 644 being folded about first and second folding lines 640a and 640b and having smaller widths than the rear cover 640 are connected to a lower end of the front cover 640, and a first iron piece 641 to be attached to the first magnet piece 621 is installed on a lower end of the second sub-rear cover 644.

A second magnet piece 622, to which the first iron piece 641 can be attached, is installed on a lower end of the front cover 620. In this case, a second iron piece 623 having a clip shape, in which the first iron piece 641 can be built, is installed on the lower end of the front cover 620.

### BRIEF DESCRIPTION OF THE DRAWINGS

FIG. 1 is a perspective view of a multipurpose supportable cover according to a first embodiment of the present invention;

FIG. 2 is a perspective view illustrating the multipurpose supportable cover shown in FIG. 1 that is in a standing state;

FIG. 3 is a perspective view illustrating the multipurpose supportable cover shown in FIG. 1 when a second sub-rear cover is folded to face a front cover in order to carry the supportable cover;

FIG. 4 is a perspective view illustrating the multipurpose supportable cover shown in FIG. 1 when a first sub-rear cover and the second sub-rear cover are folded to face a main rear cover in order to frequently use the supportable cover;

FIG. 5 is a perspective view illustrating the use of a second sub-rear cover narrower than the main rear cover instead of the second sub-rear cover included in the multipurpose supportable cover shown in FIG. 1;

FIG. 6 is a perspective view for illustrating a cover end included in the multipurpose supportable cover of FIG. 1 in order to cover a filler page portion;

FIG. 7 is a perspective view of a multipurpose supportable cover according to a second embodiment of the present invention;

FIG. 8 is a perspective view illustrating the use of a second sub-rear cover narrower than a main rear cover instead of a second sub-rear cover included in the multipurpose supportable cover shown in FIG. 7;

FIG. 9 is a perspective view of a multipurpose supportable cover according to a third embodiment of the present invention;

FIG. 10 is a perspective view illustrating the multipurpose supportable cover shown in FIG. 9 that is in a standing state;

FIG. 11 is a perspective view illustrating the multipurpose supportable cover shown in FIG. 9 when a sub-rear cover is folded to face a stepped portion in order to carry the supportable cover;

FIG. 12 is a perspective view of a multipurpose supportable cover according to a fourth embodiment of the present invention;

FIG. 13 is a perspective view illustrating the multipurpose supportable cover shown in FIG. 12 when a sub-rear cover is folded to face a stepped portion in order to carry the supportable cover;

FIG. 14 is a perspective view of a multipurpose supportable cover according to a fifth embodiment of the present invention;

FIG. 15 is a perspective view illustrating the multipurpose supportable cover shown in FIG. 14 that is in a standing state;

FIG. 16 is a perspective view illustrating the multipurpose supportable cover shown in FIG. 15 when a sub-front cover and a sub-rear cover are folded to face stepped portions in order to carry the supportable cover;

FIG. 17 is a perspective view of a multipurpose supportable cover according to a sixth embodiment of the present invention;

FIG. 18 is a perspective view illustrating the multipurpose supportable cover shown in FIG. 17 that is in a standing state;

FIG. 19 is a perspective view of a multipurpose supportable cover according to a seventh embodiment of the present invention; and

FIG. 20 is a perspective view illustrating the multipurpose supportable cover shown in FIG. 19 when a second sub-rear cover is folded to face a front cover in order to carry the supportable cover.

### BEST MODE FOR CARRYING OUT THE INVENTION

Hereinafter, the present invention will be described in detail by explaining preferred embodiments of the invention with reference to the attached drawings.

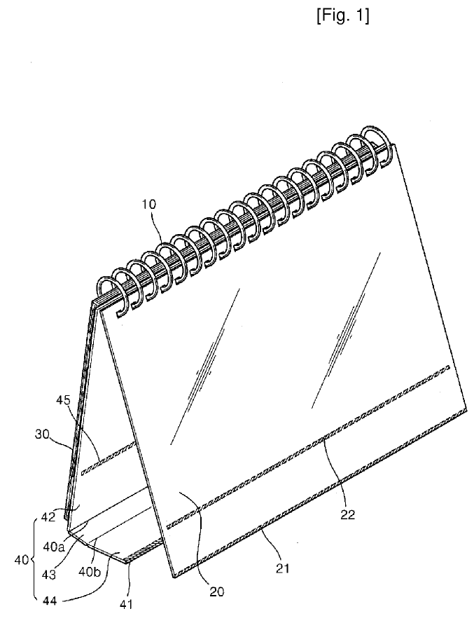

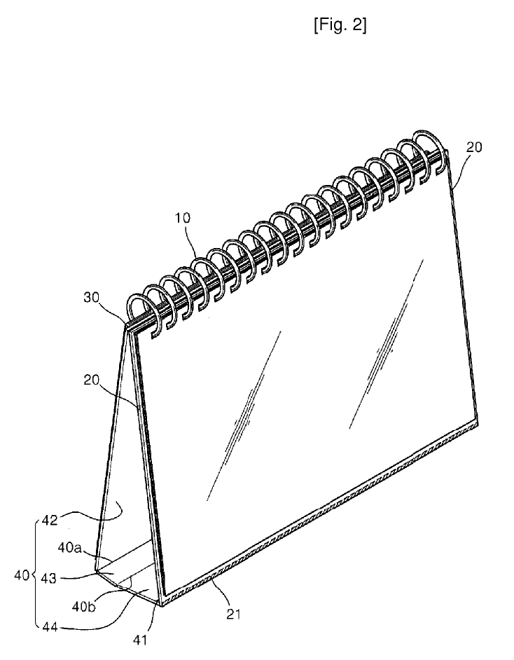

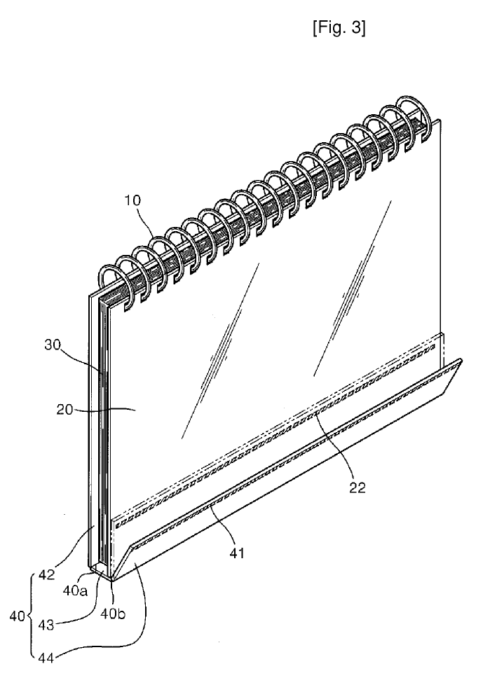

FIG. 1 is a perspective view of a multipurpose supportable cover according to a first embodiment of the present invention. FIG. 2 is a perspective view illustrating the supportable cover shown in FIG. 1 that is in a standing state. FIG. 3 is a perspective view illustrating the multipurpose supportable cover shown in FIG. 1 when a second sub-rear cover is folded to face a front cover in order to carry the supportable cover.

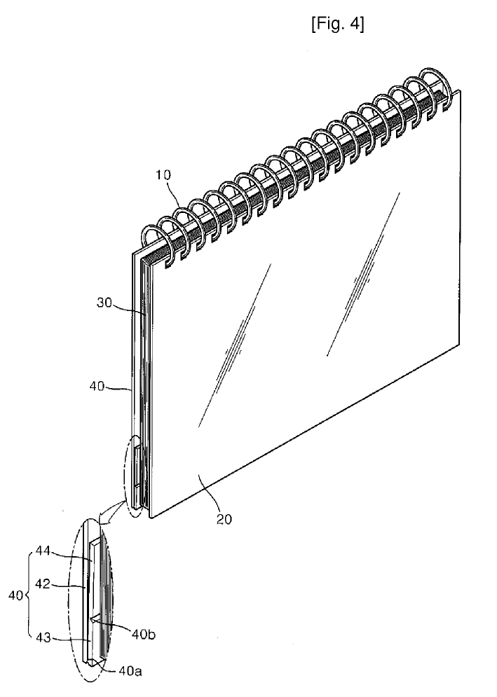

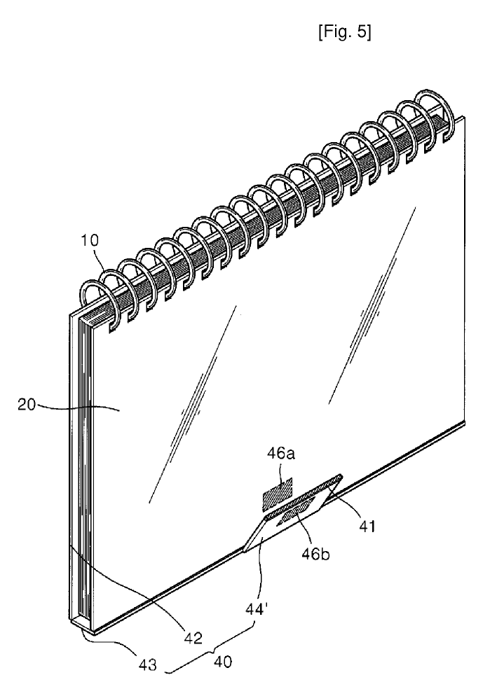

FIG. 4 is a perspective view illustrating the multipurpose supportable cover shown in FIG. 1 when a first sub-rear cover and the second sub-rear cover are folded to face a main rear cover in order to frequently use the supportable cover. FIG. 5 is a perspective view illustrating the use of a second sub-rear cover narrower than the main rear cover instead of the second sub-rear cover included in the multipurpose supportable cover shown in FIG. 1.

As illustrated in FIGS. 1 through 5, the supportable cover according to the first embodiment includes a front cover 20, a filler page portion 30, and a rear cover 40 that are bound by a binder 10, such as, a ring binder or a coil.

The front cover 20 is arranged in front of the filler page portion 30, and the rear cover 40 is arranged in rear of the filler page portion 30. In this state, the binder 10 penetrates holes formed in the upper parts of the front cover 20, the filler page portion 30, and the rear cover 40, so that the front cover 20, the filler page portion 30, and the rear cover 40 are bound to each other. In the present embodiment, the binder 10 is a coil spring. However, the binder 10 may be the other various structures.

The filler page portion 30 includes front cover filler pages on which images are printed, calendar filler pages on which the dates and days of a particular year are displayed in units of months or weeks, information note filler pages on which notes representing typical situations frequently happening in workplaces, such as, “I am in a meeting now”, or “I am out now”, or “I am on a business trip”, memo filler pages on which memos can be written down, notebook filler pages for taking notes, telephone number filler pages on which telephone numbers can be written down, address filler pages on which addresses can be written down, album filler pages on which pictures or images desired to be kept or exhibited as mementos, or map filler pages on which maps are printed. Besides, the filler page portion 30 may be a book on which poems or meditations are printed.

A first iron piece 21 is installed on the lower end of the front cover 20. A second iron piece 22 is installed over the first iron piece 21. Although the first and second iron pieces 21 and 22 are illustrated as long bars formed of a magnetic material in FIG. 1, they may be implemented as a button, a specific geometric figure, etc. The first and second iron pieces 21 and 22 may also be completely built in or exposed to the front cover 20.

A magnet piece 41, being attached to the first iron piece 21, is installed in the lower end of the rear cover 40. Although the magnet piece 41 is illustrated as a long bar formed of a magnetic material in FIG. 1, it may be implemented as a button, a specific geometric figure, etc. The magnet piece 41 may also be completely built in or exposed to the lower end of the rear cover 40. In particular, when the first iron piece 21 is implemented as an array of clips, the appearance of the supportable cover can be improved.

The rear cover 40 includes a main rear cover 42, a first sub-rear cover 43, and a second sub-rear cover 44 that are partitioned by first and second folding lines 40a and 40b. The magnet piece 41 is installed on the lower end of the second sub-rear cover 44.

In the present embodiment, the first and second sub-rear covers 43 and 44 have the same widths as that of the main rear cover 42. However, the first and second sub-rear covers 43 and 44 may have widths smaller than that of the main rear cover 42.

A third iron piece 45, to which the magnet piece 41 is attached when the first and second sub-rear covers 43 and 44 fold, is installed on the main rear cover 42. Although the third iron piece 45 is illustrated as a long bar formed of a magnetic material in FIG. 1, it may be in the shape of a button, a specific geometric figure, etc. The third iron piece 45 may also be completely built in or exposed to the main rear cover 42.

As illustrated in FIG. 5, the second sub-rear cover 44 may have a width smaller than that of the main rear cover 42 and thus be turned into a second sub-rear cover 44′. In this case, special attaching members 46a and 46b are installed on the front cover 20 and the second sub-rear cover 44′ so that the second sub-rear cover 44′ is securely attached to the front cover 20. The attaching members 46a and 46b may be implemented as a snap fastener, a velcro, or a combination of a magnet and an iron piece.

The front and rear covers 20 and 40 needs to have a certain level of firmness in order to stand on a table, such that they are manufactured by injecting polypropylene (which is generally called PP) that is highly firm and cost-effective, or formed of acryl, paper such as hardboard, plastic, aluminum, wood, etc. However, to add a high quality, the front and rear covers 20 and 40 may be, of course, covered with a natural leather, a synthetic leather, or cloth that provide esthetic senses.

Various sizes of pockets may be formed on an inside surface of the front or rear cover 20 or 40 so that cards, name cards, ID cards, etc. are kept therein.

Although the second sub-rear cover 44′ having a width smaller than that of the main rear cover 42 is illustrated in FIG. 5, this is an embodiment of the present invention. Of course, the first sub-rear cover 43 may have a small width like the second sub-rear cover 44′.

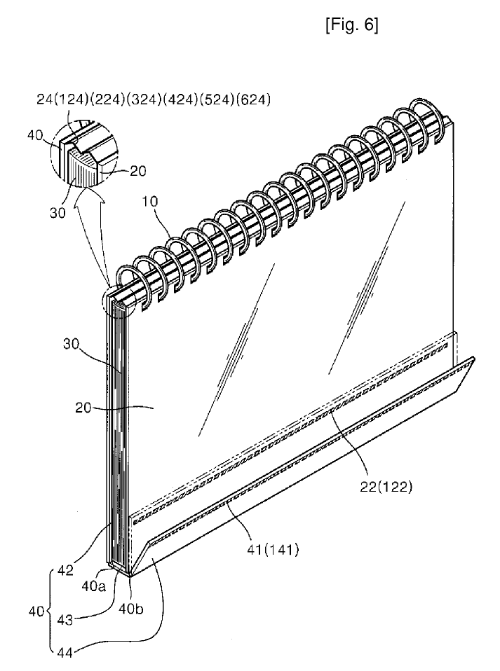

FIG. 6 is a perspective view for illustrating a cover end 24 included in the multipurpose supportable cover of FIG. 1 in order to cover the filler page portion 30.

The cover end 24 covering the filler page portion 30 may be connected to ends of the front and rear covers 20 and 40 that are close to the binder 10. Preferably, the cover end 24 is wrinkled to be folded when the front and rear covers 20 and 40 are opened and closed. Although the cover end 24 existing inside the binder 10 is illustrated in FIG. 6, it may be installed outside the binder 10. The installation of the cover end 24 can make the overall appearance of the supportable cover of FIG. 1.

In an operation of the multipurpose supportable cover according to the first embodiment having the above-described structure, as illustrated in FIG. 2, when the multipurpose supportable cover is desired to be used standing on a table, the first and second sub-rear covers 43 and 44 folded up on the main rear cover 42 about the first folding line 40a is unfolded, and then the magnet piece 41 installed on the second sub-rear cover 44 is attached to the first iron piece 21, which is installed on the lower end of the front cover 20. Then, as viewed from the side of the multipurpose supportable cover, the cover stands while forming a triangle.

As illustrated in FIG. 3, when the multipurpose supportable cover is desired to be carried, the first sub-rear cover 43 is first unfolded from the main rear cover 42 about the first folding line 40a, and the second sub-rear cover 44 is then unfolded from the first sub-rear cover 43 about the second folding line 40b. Then, the magnet piece 41 installed on the second sub-rear cover 44 is attached to the second iron piece 22 installed over the first iron piece 21 of the front cover 20. In FIG. 3, the second sub-rear cover 44 is attached to an outside surface of the front cover 20. However, of course, the second sub-rear cover 44 may be attached to an inside surface of the front cover 20.

As illustrated in FIG. 4, when the multipurpose supportable cover is desired to be frequently used, the first and second sub-rear covers 43 and 44 are folded up about the first folding line 40a so as to face the main rear cover 42. In this state, the front cover 20 can be easily opened.

In other words, when the filler page portion 30 includes album filler pages, the supportable cover in the folded state can be used as an album, and the standing supportable cover can be used as a desk frame.

When the filler page portion 30 is implemented as a book, the book can stand like a calendar, so that books emphasizing the beauty of images can be more effectively used or users can read the book more conveniently.

When the filler page portion 30 is implemented as a notebook, the multipurpose supportable cover can function as both a notebook and a book support. Thus, when reading a book on the supportable cover, users do not need to bend their necks or hold the book with their hands. This makes the users more convenient.

Besides, when employees working in the bank, the insurance company, the finance-related company, etc. introduce their financial products to clients, the use of the supportable cover makes the clients view the same contents of the products together with the employees. Moreover, the usage purpose of the supportable cover can be expanded to a name card album, an address book, and the other office purposes.

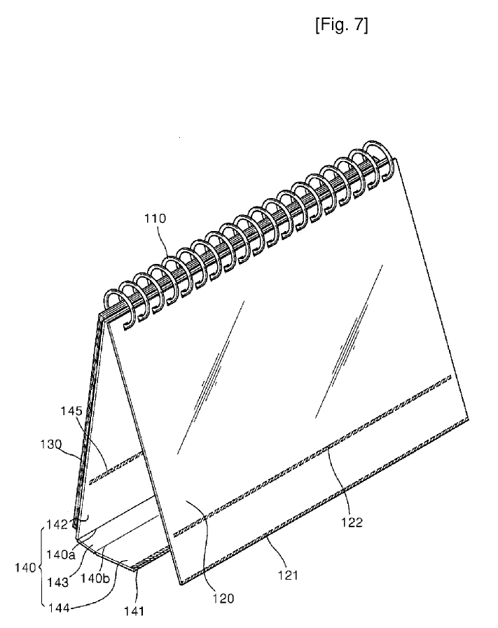

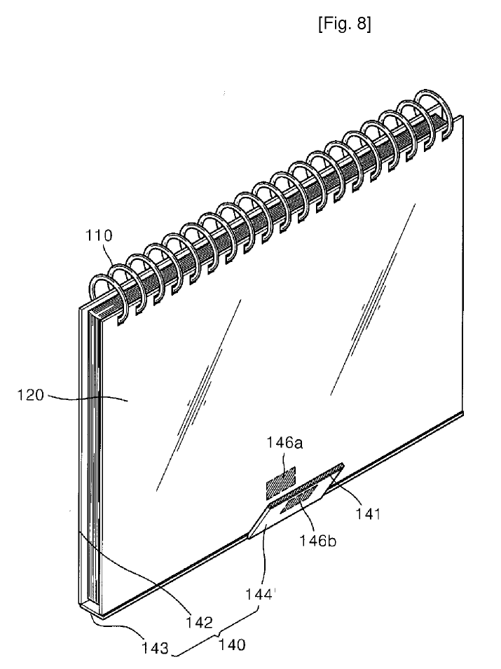

A multipurpose supportable cover according to a second embodiment of the present invention will now be described with reference to FIGS. 7 and 8.

FIG. 7 is a perspective view of a multipurpose supportable cover according to a second embodiment of the present invention. FIG. 8 is a perspective view illustrating the use of a second sub-rear cover 144′ narrower than a main rear cover 142 instead of a second sub-rear cover 144 included in the multipurpose supportable cover shown in FIG. 7.

As illustrated in FIGS. 7 and 8, the multipurpose supportable cover according to the second embodiment includes a binder 110, a front cover 120, a filler page portion 130, and a rear cover 140 that are similar to those of the first embodiment.

A first magnet piece 121 is installed on the lower end of the front cover 120. A second magnet piece 122 is installed over the first magnet piece 121. Although the first and second magnet pieces 121 and 122 are illustrated as long bars formed of a magnetic material in FIG. 7, they may be implemented as a button, a specific geometric figure, etc. The first and second magnet pieces 121 and 122 may also be completely built in or exposed to the front cover 120.

An iron piece 141, being attached to the first magnet piece 121, is installed in the lower end of the rear cover 140. Although the magnet piece 141 is illustrated as a long bar in FIG. 7, it may be implemented as a button, a specific geometric figure, etc. The iron piece 141 may also be completely built in or exposed to the lower end of the rear cover 140.

The rear cover 140 includes the main rear cover 142, a first sub-rear cover 143, and the second sub-rear cover 144 that are partitioned by first and second folding lines 140a and 140b. The iron piece 141 is installed on the lower end of the second sub-rear cover 144.

In the present embodiment, the first and second sub-rear covers 143 and 144 have the same widths as that of the main rear cover 142. However, the first and second sub-rear covers 143 and 144 may have widths smaller than that of the main rear cover 142.

A third magnet piece 145, to which the iron piece 141 is attached when the first and second sub-rear covers 143 and 144 fold to face each other, is installed on the main rear cover 142. Although the third magnet piece 145 is illustrated as a long bar formed of a magnetic material in FIG. 7, it may be in the shape of a button, a specific geometric figure, etc. The third magnet piece 145 may also be completely built in or exposed to the main rear cover 142.

Similar to the first embodiment, as illustrated in FIG. 8, the second sub-rear cover 144 may have a width smaller than that of the main rear cover 142 and thus be turned into the second sub-rear cover 144′. In this case, special attaching members 146a and 146b are installed on the front cover 120 and the second sub-rear cover 144′ so that the second sub-rear cover 144′ is securely attached to the front cover 120. The attaching members 46a and 46b may be implemented as a snap fastener, a Velcro, or a combination of a magnet and an iron piece.

As illustrated in FIG. 6, in order to cover the filler page portion 130, a cover end 124 may be connected to ends of the front and rear covers 120 and 140 that are close to the binder 110. Preferably, the cover end 124 is wrinkled to be folded when the front and rear covers 120 and 140 are opened and closed.

An operation of the multipurpose supportable cover according to the second embodiment is the same as that of the multipurpose supportable cover according to the first embodiment, so a description thereof will be omitted.

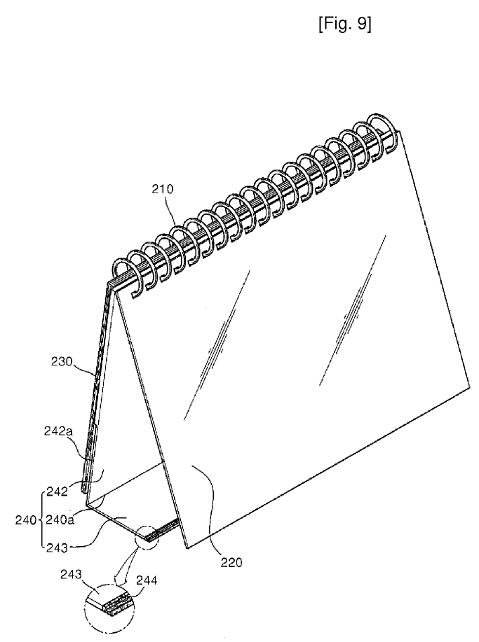

A multipurpose supportable cover according to a third embodiment of the present invention will now be described with reference to FIGS. 9, 10, and 11.

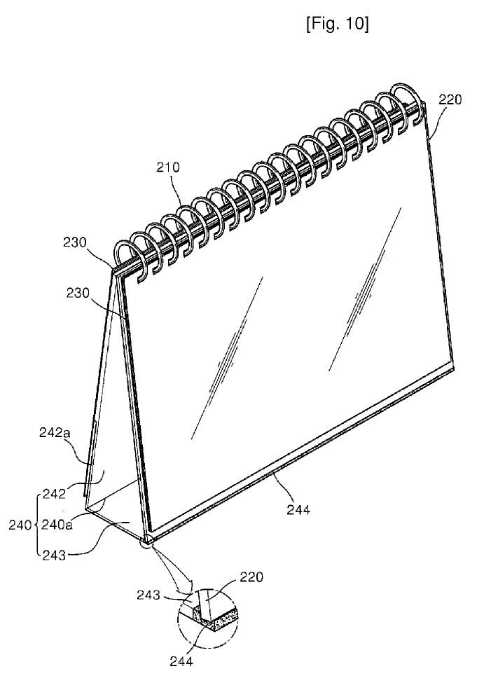

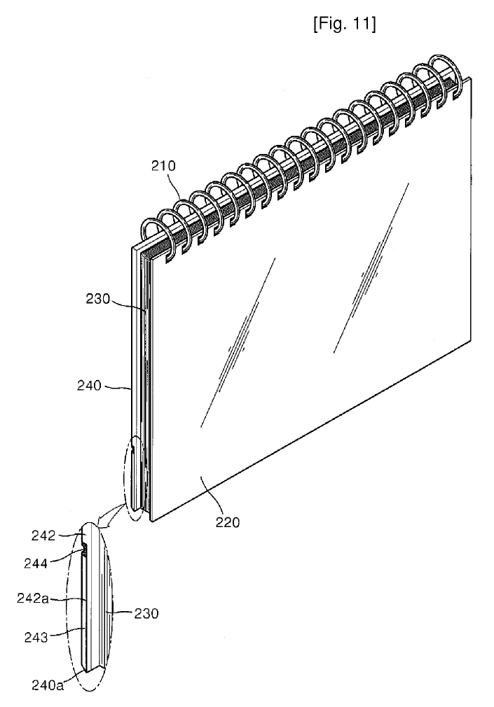

FIG. 9 is a perspective view of a multipurpose supportable cover according to a third embodiment of the present invention. FIG. 10 is a perspective view illustrating the multipurpose supportable cover shown in FIG. 9 that is in a standing state. FIG. 11 is a perspective view illustrating the multipurpose supportable cover shown in FIG. 9 when a sub-rear cover 243 is folded to face a stepped portion 242a in order to carry the supportable cover.

As illustrated in FIGS. 9 through 11, the supportable cover according to the third embodiment includes a binder 210, a front cover 220, a filler page portion 230, and a rear cover 240 that are similar to those of the first and second embodiments.

The rear cover 240 includes a main rear cover 242 and the sub-rear cover 243 that are partitioned by a folding line 240a. An insertion piece 244 having a concave cross-section so that an end of the front cover 220 is inserted thereinto is installed on an end of the sub-rear cover 243.

A lower portion of the main rear cover 242 is horizontally stepped and thus turned into the stepped portion 242a thinner than the other portion of the main rear cover 242, when the sub-rear cover 243 is folded about the folding line 240a to face the stepped portion 242a, the entire rear surface of the rear cover 240 is closely attached to the filler page portion 230. To achieve this, the thickness of the stepped portion 242a is set such that a sum of the thicknesses of the stepped portion 242a and the sub-rear cover 243 is equal to the thickness of the main rear cover 242. In the present embodiment, the stepped portion 242a is used to improve the appearance of the supportable cover. However, the stepped portion 242a may not be used at manufacturer's own will. It does not matter whether the direction in which the sub-rear cover 243 is bent is inward or outward the main rear cover 242.

As illustrated in FIG. 6, in order to cover the filler page portion 230, a cover end 224 may be connected to ends of the front and rear covers 220 and 240 that are close to the binder 210. Preferably, the cover end 224 is wrinkled to be folded when the front and rear covers 220 and 240 are opened and closed.

In an operation of the multipurpose supportable cover according to the third embodiment having the above-described structure, as illustrated in FIG. 10, when the multipurpose supportable cover is desired to be used standing on a table, the sub-rear cover 243 folded to face the main rear cover 242 about the folding line 240a is unfolded, and then the lower end of the front cover 240 is inserted into the insertion piece 244 formed on the sub-rear cover 243. Then, as viewed from the side of the multipurpose supportable cover, the cover stands while forming a triangle.

As illustrated in FIG. 11, when the multipurpose supportable cover is desired to be carried, the sub-rear cover 243 is folded about the folding line 240a so as to face the stepped portion 242a of the main rear cover 242. Because the thickness of the stepped portion 242a is smaller than that of the main rear cover 242, a sum of the sub-rear cover 243 and the stepped portion 242a folded together is the same as the thickness of the main rear cover 242. Hence, when the sub-rear cover 243 is folded to face the stepped portion 242a, the entire rear surface of the rear cover 240 is closed attached to the filler page portion 230. This contributes to improving the portability of the supportable cover.

The other operations of the multipurpose supportable cover according to the third embodiment are the same as those of the first and second embodiments, so a detailed description thereof will be omitted.

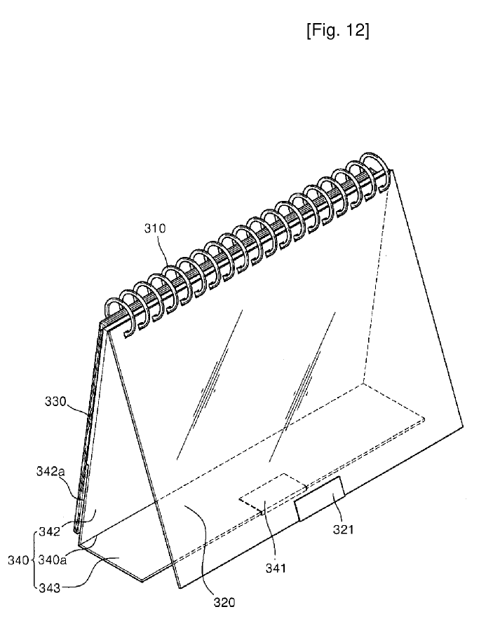

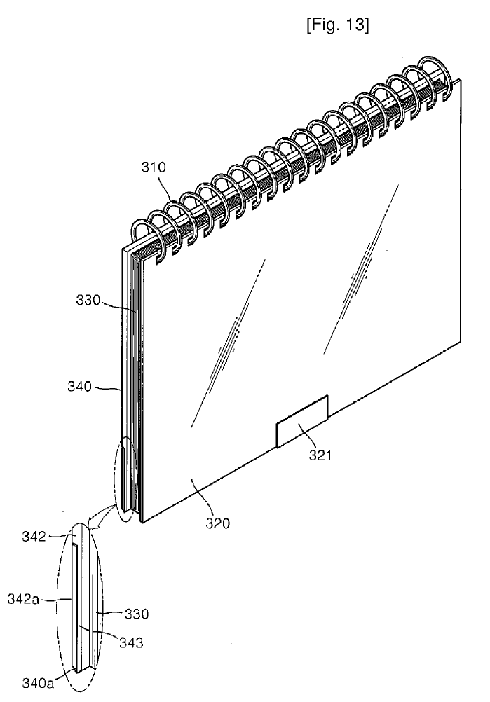

A multipurpose supportable cover according to a fourth embodiment of the present invention will now be described with reference to FIGS. 12 and 13.

FIG. 12 is a perspective view of a multipurpose supportable cover according to a fourth embodiment of the present invention. FIG. 13 is a perspective view illustrating the multipurpose supportable cover shown in FIG. 12 when a sub-rear cover 343 is folded to face a stepped portion 342a in order to carry the supportable cover.

As illustrated in FIGS. 12 and 13, the supportable cover according to the fourth embodiment includes a binder 310, a front cover 320, a filler page portion 330, and a rear cover 340 that are similar to those of the first and second embodiments. The rear cover 340 includes a main rear cover 342 and the sub-rear cover 343 that are partitioned by a folding line 340a.

A first magnetic body is installed on either an end of the sub-rear cover 343 or an end of the front cover 320, and a second magnetic body to be attached to the first magnetic body is installed on the remaining end. One of the first and second magnetic bodies is a magnet, and the other is an iron piece. Preferably, the iron piece has a shape of a clip fit onto either the end of the sub-rear cover 343 or the end of the front cover 320. However, of course, the first and second magnetic bodies may be N and S magnets that face each other to be attached together.

In the present embodiment, a clip-shaped iron piece 321 is installed as a magnetic body on an end of the front cover 320, and a magnet piece 341 is installed as a magnetic body on an end of the sub-rear cover 343.

A lower portion of the main rear cover 342 is horizontally stepped and thus turned into the stepped portion 342a thinner than the other portion of the main rear cover 342. When the sub-rear cover 343 is folded about the folding line 340a to face the stepped portion 342a, the entire rear surface of the rear cover 340 is closely attached to the filler page portion 330. To achieve this, the thickness of the stepped portion 342a is set such that a sum of the thicknesses of the stepped portion 342a and the sub-rear cover 343 is equal to the thickness of the main rear cover 342.

In the present embodiment, the stepped portion 342a is used to improve the appearance of the supportable cover. However, the stepped portion 342a may not be used at manufacturers own will. Also, although the sub-rear cover 343 having the same width as that of the main rear cover 342 is illustrated in the fourth embodiment, the sub-rear cover 343 may be narrower than the main rear cover 342.

As illustrated in FIG. 13, when the multipurpose supportable cover is desired to be carried, the sub-rear cover 343 is folded about the folding line 340a so as to face the stepped portion 342a of the main rear cover 342. Because the thickness of the stepped portion 342a is smaller than that of the main rear cover 342, a sum of the sub-rear cover 343 and the stepped portion 342a folded together is the same as the thickness of the main rear cover 342. Hence, when the sub-rear cover 343 is folded to face the stepped portion 342a, the entire rear surface of the rear cover 340 is closed attached to the filler page portion 330. This contributes to improving the portability of the supportable cover.

As illustrated in FIG. 6, in order to cover the filler page portion 330, a cover end 324 may be connected to ends of the front and rear covers 320 and 340 that are close to the binder 310. Preferably, the cover end 324 is wrinkled to be folded when the front and rear covers 320 and 340 are opened and closed.

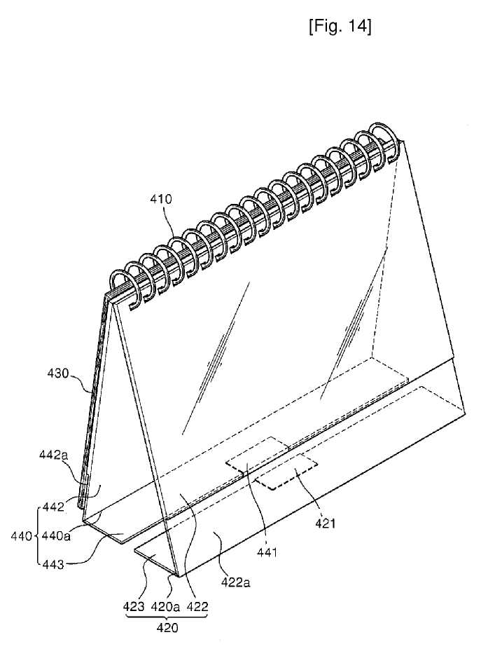

A multipurpose supportable cover according to a fifth embodiment of the present invention will now be described with reference to FIGS. 14, 15, and 16.

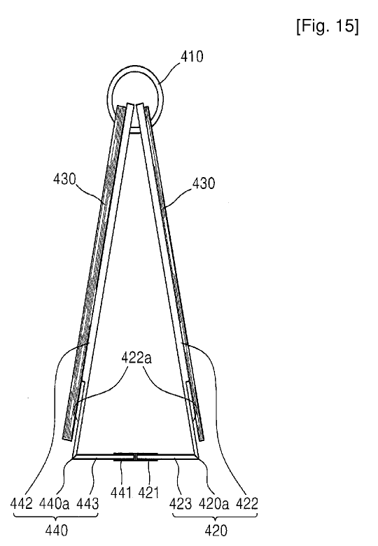

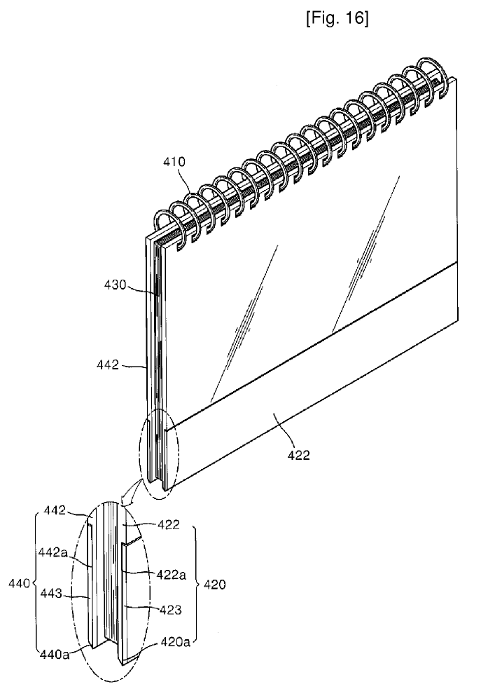

FIG. 14 is a perspective view of a multipurpose supportable cover according to a fifth embodiment of the present invention. FIG. 15 is a perspective view illustrating the multipurpose supportable cover shown in FIG. 14 that is in a standing state. FIG. 16 is a perspective view illustrating the multipurpose supportable cover shown in FIG. 15 when a sub-front cover 423 and a sub-rear cover 443 are folded to face stepped portions 422a and 442a in order to carry the supportable cover.

As illustrated in FIGS. 14, 15, and 16, the supportable cover according to the fifth embodiment includes a binder 410, a front cover 420, a filler page portion 430, and a rear cover 440 that are similar to those of the first, second, and third embodiments.

The front cover 420 includes a main front cover 422 and the sub-front cover 423 that are partitioned by a folding line 420a. A lower portion of the main front cover 422 is horizontally stepped and thus turned into the stepped portion 422a thinner than the other portion of the main front cover 422. When the sub-front cover 423 is folded about the folding line 420a, it faces the stepped portion 422a.

The rear cover 440 includes a main rear cover 442 and the sub-rear cover 443 that are partitioned by a folding line 440a. A lower portion of the main rear cover 442 is horizontally stepped and thus turned into the stepped portion 442a thinner than the other portion of the main rear cover 442. When the sub-rear cover 443 is folded about the folding line 440a, it faces the stepped portion 442a.

In the present embodiment, the stepped portions 422a and 442a are used to improve the appearance of the supportable cover. However, the stepped portions 422a and 442a may not be used at manufacturers own will. Also, although the sub-front cover 423 and sub-rear cover 443 having the same width as those of the main front cover 422 and the main rear cover 442, respectively, are illustrated in the fifth embodiment, the sub-front cover 423 and the sub-rear cover 443 may be narrower than the main front cover 422 and the main rear cover 442, respectively.

A first magnetic body is installed on either an end of the sub-front cover 423 or an end of the sub-rear cover 443, and a second magnetic body to be attached to the first magnetic body is installed on the remaining end. One of the first and second magnetic bodies is a magnet, and the other is an iron piece. Preferably, the iron piece has a shape of a clip fit onto either the end of the sub-front cover 423 or the end of the sub-rear cover 443. However, of course, the first and second magnetic bodies may be N and S magnets that face each other to be attached together. In the present embodiment, a clip-shaped iron piece 421 is installed as a magnetic body on an end of the sub-front cover 423, and a magnet piece 441 is installed as a magnetic body on an end of the sub-rear cover 443.

As illustrated in FIG. 6, in order to cover the filler page portion 430, a cover end 424 may be connected to ends of the front and rear covers 420 and 440 that are close to the binder 410. Preferably, the cover end 424 is wrinkled to be folded when the front and rear covers 420 and 440 are opened and closed.

In an operation of the multipurpose supportable cover according to the fifth embodiment having the above-described structure, as illustrated in FIG. 15, when the multipurpose supportable cover is desired to be used standing on a table, the sub-front cover 423 and the sub-rear cover 443 are unfolded from the main front cover 422 and the main rear cover 442, respectively, about the folding lines 420a and 440a, and then the iron piece 241 and the magnet piece 441 installed on the ends of the sub-front cover 423 and the sub-rear cover 443, respectively, are attached to each other. Then, as viewed from the side of the multipurpose supportable cover, the cover stands while forming a triangle.

A lower portion of the main front cover 422 is horizontally stepped and thus turned into the stepped portion 422a thinner than the other portion of the main front cover 422. When the sub-front cover 423 is folded about the folding line 420a to face the stepped portion 422a, the entire rear surface of the rear cover 440 is closely attached to the filler page portion 430. To achieve this, the thickness of the stepped portion 422a is set such that a sum of the thicknesses of the stepped portion 422a and the sub-front cover 423 is equal to the thickness of the main front cover 422.

A lower portion of the main rear cover 442 is horizontally stepped and thus turned into the stepped portion 442a thinner than the other portion of the main rear cover 442. When the sub-rear cover 443 is folded about the folding line 440a to face the stepped portion 442a, the entire rear surface of the rear cover 440 is closely attached to the filler page portion 430. To achieve this, the thickness of the stepped portion 442a is set such that a sum of the thicknesses of the stepped portion 442a and the sub-rear cover 443 is equal to the thickness of the main rear cover 442.

As illustrated in FIG. 16, when the multipurpose supportable cover is desired to be carried, the sub-front cover 423 and the sub-rear cover 443 are folded about the folding lines 420a and 440a so as to face the stepped portions 422a and 442a of the main front cover 422 and the main rear cover 442, respectively. Because the thicknesses of the stepped portions 422a and 442a are smaller than those of the main front cover 422 and the main rear cover 442, respectively, a sum of the sub-front cover 423 and the stepped portion 422a folded together is the same as the thickness of the main front cover 422, and a sum of the sub-rear cover 443 and the stepped portion 442a folded together is the same as the thickness of the main rear cover 442. Hence, when the sub-front cover 423 and the sub-rear cover 443 are folded to face the stepped portions 422a and 442a, respectively, the entire rear surfaces of the front and rear covers 420 and 440 are closed attached to the filler page portion 430. This contributes to improving the portability of the supportable cover.

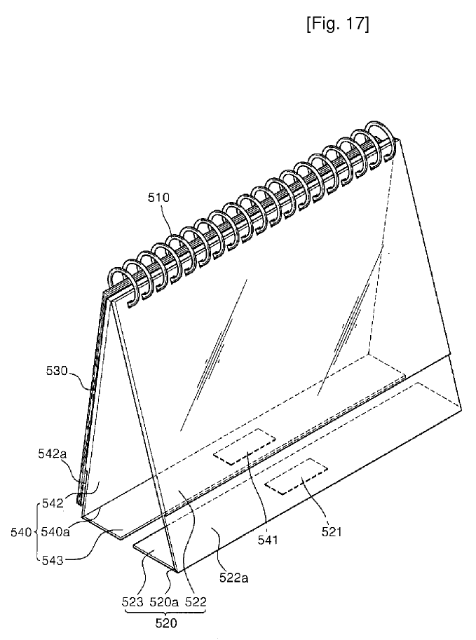

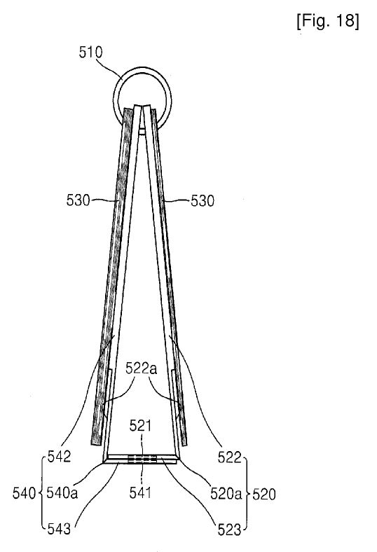

A multipurpose supportable cover according to a sixth embodiment of the present invention will now be described with reference to FIGS. 17 and 18.

FIG. 17 is a perspective view of a multipurpose supportable cover according to a sixth embodiment of the present invention. FIG. 18 is a perspective view illustrating the multipurpose supportable cover shown in FIG. 17 that is in a standing state.

As illustrated in FIGS. 17 and 18, the supportable cover according to the sixth embodiment includes a binder 510, a front cover 520, a filler page portion 530, and a rear cover 540 that are similar to those of the first, second, third, fourth, and fifth embodiments.

As in the fifth embodiment, the front cover 520 includes a main front cover 522 and a sub-front cover 523 that are partitioned by a folding line 520a. A lower portion of the main front cover 522 is horizontally stepped and thus turned into a stepped portion 522a thinner than the other portion of the main front cover 522. When the sub-front cover 523 is folded about the folding line 520a, it faces the stepped portion 522a.

The rear cover 540 includes a main rear cover 542 and the sub-rear cover 543 that are partitioned by a folding line 540a. A lower portion of the main rear cover 542 is horizontally stepped and thus turned into a stepped portion 542a thinner than the other portion of the main rear cover 542. When the sub-rear cover 543 is folded about the folding line 540a, it faces the stepped portion 542a.

In the present embodiment, the stepped portions 522a and 542a are used to improve the appearance of the supportable cover. However, the stepped portions 522a and 542a may not be used at manufacturers own will. Also, although the sub-front cover 523 and sub-rear cover 543 having the same widths as those of the main front cover 522 and the main rear cover 542, respectively, are illustrated in the sixth embodiment, the sub-front cover 523 and the sub-rear cover 543 may be narrower than the main front cover 522 and the main rear cover 542, respectively.

In the sixth embodiment, first and second magnetic bodies are embedded in the sub-front cover 523 and the sub-rear cover 543 so as not to be exposed to the outside, instead of being installed on an end of the sub-front cover 523 and an end of the sub-rear cover 543. One of the first and second magnetic bodies is a magnet, and the other is an iron piece. However, of course, the first and second magnetic bodies may be N and S magnets that face each other to be attached together. In the present embodiment, an iron piece 521 is installed as a magnetic body on an end of the sub-front cover 523, and a magnet piece 541 is installed as a magnetic body on an end of the sub-rear cover 543.

As illustrated in FIG. 6, in order to cover the filler page portion 530, a cover end 524 may be connected to ends of the front and rear covers 520 and 540 that are close to the binder 510. Preferably, the cover end 524 is wrinkled to be folded when the front and rear covers 520 and 540 are opened and closed.

In an operation of the multipurpose supportable cover according to the sixth embodiment having the above-described structure, as illustrated in FIG. 18, when the multipurpose supportable cover is desired to be used standing on a table, the sub-front cover 523 and the sub-rear cover 543 are unfolded from the main front cover 522 and the main rear cover 542, respectively, about the folding lines 520a and 540a, and then the sub-front cover 523 and the sub-rear cover 543 are put one upon another. Then, the iron piece 521 and the magnet piece 541 embedded in the sub-front cover 523 and the sub-rear cover 543, respectively, are attached to each other, so that as viewed from the side of the multipurpose supportable cover, the cover stands while forming a triangle.

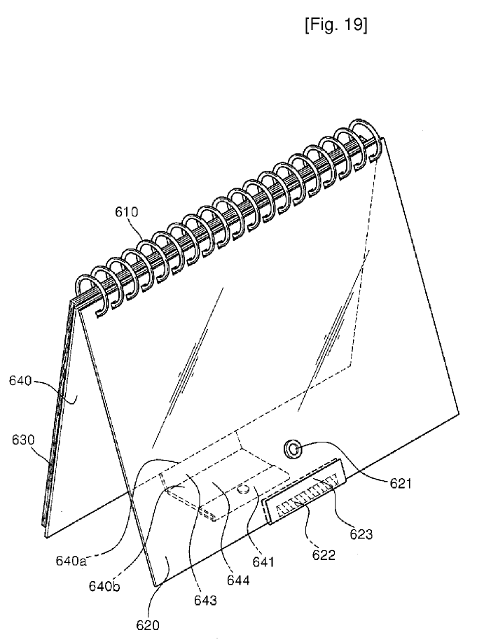

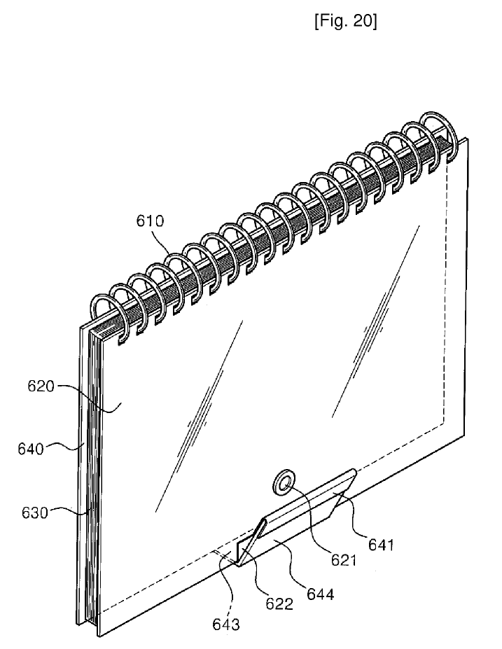

A multipurpose supportable cover according to a seventh embodiment of the present invention will now be described with reference to FIGS. 19 and 20.

FIG. 19 is a perspective view of a multipurpose supportable cover according to a seventh embodiment of the present invention. FIG. 20 is a perspective view illustrating the multipurpose supportable cover shown in FIG. 19 when a second sub-rear cover 643 is folded to face a front cover 620 in order to carry the supportable cover.

As illustrated in FIGS. 19 and 20, the supportable cover according to the seventh embodiment includes a binder 610, a front cover 620, a filler page portion 630, and a rear cover 640 that are similar to those of the first, second, third, fourth, and fifth embodiments.

A first magnet piece 621 is installed on the front cover 620. First and second sub-rear covers 643 and 644, being folded about first and second folding lines 640a and 640b and having widths smaller than the rear cover 640, are connected on the lower end of the rear cover 640. A first iron piece 641, being attached to the first magnet piece 621, is installed on an end of the second sub-rear cover 644. A second magnet piece 622 capable of being attached to the first iron piece 641 is installed on the lower end of the front cover 620. A second iron piece 623 having a clip shape is installed on the lower end of the front cover 620 and embeds the second magnet piece 622 therein. As illustrated in FIG. 6, in order to cover the filler page portion 630, a cover end 624 may be connected to ends of the front and rear covers 620 and 640 that are close to the binder 610. Preferably, the cover end 624 is wrinkled to be folded when the front and rear covers 620 and 640 are opened and closed.

In the present embodiment, the first magnet piece 621 installed on the front cover 620 and the first iron piece 641, being attached to the first magnet piece 621, installed on the second sub-rear cover 643 are used. However, the first magnet piece 621 and the first iron piece 641 may be implemented as buttons that can be attached to or detached from each other. A magnet instead of an iron piece may be used as an element to which the magnet piece 621 is attached.

Although the first and second sub-rear covers 643 and 644 having smaller widths than the first rear cover 640 are illustrated in FIG. 19, they may have the same widths as that of the first rear cover 640.

An operation of the multipurpose supportable cover according to the seventh embodiment is similar to those of the above-described embodiments, so a detailed description thereof will be omitted.

In the first through seventh embodiments, a coil sprint is used as a binder that binds a front cover and a rear cover. However, various structures that can replace the coil sprint may be used as the binder.

The inventions stated in the first through seventh embodiments may be applied to various products, such as, a calendar, a diary, an album, a book, a notebook, sample holders of various products (e.g., tiles or wall paper), and a name card stand, according to the type of filler paper.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

As described above, various functions of a multipurpose supportable cover according to the present invention can be applied to a scheduler, a desk calendar, a memo pad, a notebook, a name card book, an address book, a book, or a picture book, etc., as occasion demands. Thus, the portability and usability of a product to which the supportable cover is applied can be improved.

Also, when an iron piece or a magnet piece, being detached from or attached to each other so as to maintain the multipurpose supportable cover in a specific shape, are completely built in a front cover and a rear cover, the appearance of the multipurpose supportable cover look simple and elegant because the iron piece or magnet piece is not exposed.

1. A multipurpose supportable cover having improved portability and usability, the cover comprising: a front cover; a filler page portion; and a rear cover, wherein: the front cover, the filler page portion, and the rear cover are bound by a binder; a first iron piece is installed on a lower end of the front cover; the rear cover comprises a main rear cover, a first sub-rear cover, and a second sub-rear cover that are partitioned by first and second folding lines and; and a magnet piece to be attached to the first iron piece is installed on a lower end of the second sub-rear cover.

2. The multipurpose supportable cover of claim 1, wherein a second iron piece, to which the magnet piece installed on the second sub-rear cover is attached when the first sub-rear cover; is first unfolded from the main rear cover about the first folding line and the second sub-rear cover is then unfolded from the first sub-rear cover about the second folding line, is installed on a portion of the front cover that is a predetermined distance apart from the first iron piece.

3. The multipurpose supportable cover of claim 1, wherein a third iron piece, to which the magnet piece is attached when the first and second sub-rear covers and are folded, is installed on the main rear cover.

4. The multipurpose supportable cover of claim 1, wherein when a second sub-rear cover having a width smaller than a width of the main rear cover is formed instead of the second sub-rear cover, special attaching members are installed on the front cover and the second sub-rear cover so that the second sub-rear cover is securely attached to the front cover.

5. The multipurpose supportable cover of claim 1, wherein a cover end covering the filler page portion is connected to ends of the front and rear covers that are close to the binder.

6. The multipurpose supportable cover of claim 5, wherein the cover end is wrinkled to be able to be folded when the front and rear covers are opened and closed.

7-13. (canceled)

14. A multipurpose supportable cover having improved portability and usability, the cover comprising: a front cover; a filler page portion, and a rear cover; wherein: the front cover, the filler page portion, and the rear cover are bound by a binder, and the rear cover comprises a main rear cover and a sub-rear cover that are partitioned by a folding line, when the sub-rear cover is folded about the folding line, and the sub-rear cover-faces the stepped portion.

15. The multipurpose supportable cover of claim 14, wherein an insertion piece having a concave cross-section so that an end of the front cover is inserted into the insertion piece is installed on an end of the sub-rear cover.

16. The multipurpose supportable cover of claim 14, wherein a first magnetic body is installed on one of an end of the sub-rear cover and an end of the front cover, and a second magnetic body to be attached to the first magnetic body is installed on the remaining end of the front cover.

17. The multipurpose supportable cover of claim 16, wherein one of the first and second magnetic bodies is a magnet, and the other is an iron piece.

18. The multipurpose supportable cover of claim 17, wherein the iron piece has a shape of a clip fit onto one of the end of the sub-rear cover and the end of the front cover.

19-27. (canceled)

28. A multipurpose supportable cover having improved portability and usability, the cover comprising: a front cover; a filler page portion; and a rear cover, wherein: the front cover, the filler page portion, and the rear cover are bound by a binder; a first magnet piece is installed oil the front cover; a first sub-rear cover and a second sub-rear cover being folded about first and second folding lines and having smaller widths than the rear cover are connected to a lower end of the front cover; and a first iron piece to be attached to the first magnet piece is installed on a lower end of the second sub-rear cover.

29. The multipurpose supportable cover of claim 28, wherein a second magnet piece, to which the first iron piece can be attached, is installed on a lower end of the front cover.

30. The multipurpose supportable cover of claim 29, wherein a second iron piece having a clip shape, in which the first iron piece can be built, is installed on the lower end of the front cover.

31. The multipurpose supportable cover of claim 29, wherein a cover end covering the filler page portion is connected to ends of the front and rear covers that are close to the binder.

32. The multipurpose supportable cover of claim 31, wherein the cover end is wrinkled to be able to be folded when the front and rear covers are opened and closed.
